(19) United States
(12) Patent Application Publication
(10) Pub. No.: US 2025/0371470 A1
(43) Pub. Date: Dec. 4, 2025

(54) SYSTEMS AND METHODS FOR INTEGRATED, AI-BASED E2E MANAGEMENT AND CONTROL

(71) Applicant: SourceDay, Inc., Austin, TX (US)

(72) Inventors: J. Coleman Newell, Austin, TX (US); Michael B. Wey, Austin, TX (US); Joshua A. Gaber, Hamilton (CA); Omkar S. Gawade, Cedar Park, TX (US); Connor G. Machon, West Lake Hills, TX (US); Venkata Sai Abhinav Ademmagari, Cedar Park, TX (US)

(73) Assignee: SourceDay, Inc., Austin, TX (US)

(21) Appl. No.: 19/217,180

(22) Filed: May 23, 2025

Related U.S. Application Data
(60) Provisional application No. 63/652,421, filed on May 28, 2024.

(51) Int. Cl. G06Q 10/0633; G06Q 10/0631

(52) U.S. Cl. CPC G06Q 10/0633; G06Q 10/06316

(57) ABSTRACT

Disclosed are systems and methods that provide a novel E2E management framework for integrated monitoring and control of interactions between interacting entities. The framework can operate or function to provide real-time assessment and management of PO-based interactions (e.g., electronic transactions) between entities, and account for security, accuracy and efficiency parameters respective to both the transacting entities and the transactions themselves. Accordingly, the disclosed framework can ensure that real-time anomalous activities are accurately and timely detected, thereby preventing unsolicited and/or malicious activity from occurring via the real-time computational analysis of the transacting parties and their electronic interactions occurring therebetween. The framework's integration in the processing between entities enhances transparency and security in procurement operations, offering a modernized approach to supply chain management.

### CROSS-REFERENCE TO RELATED APPLICATIONS

This application is a continuation of and claims the benefit of from U.S. Provisional Application No. 63/652,421, filed May 28, 2024, the contents of which are incorporated herein by reference in their entirety.

### FIELD OF THE DISCLOSURE

The present disclosure is generally related to an electronic end-to-end (E2E) management system, and more particularly, to a decision intelligence (DI)-based computerized management framework for deterministically executing detection, prioritization and automation functionality to manage real-world and digital activities by and between real-world entities.

### SUMMARY OF THE DISCLOSURE

As discussed herein, a purchase order (PO) is a standardized document, which can be embodied as an electronic data structure, that is generated by a computerized procurement system to formalize the intent of an entity (e.g., buyer) to purchase assets, goods or services from another entity (e.g., a vendor/supplier). A PO includes specific details, such as, for example, item descriptions, quantities, prices, delivery dates, supplier/vendor information and the like. Such information can be structured in a machine-readable format, allowing seamless integration with other systems and facilitating automated processing.

As discussed herein, a PO serves as a binding contract between contracting entities (e.g., buyer and seller), which outlines, for example, the terms and conditions of the transaction. Moreover, as those of skill in the art understand, POs can include information related to, but not limited to, goods, their quantity, price, delivery time frame, and the like, as discussed herein.

In some embodiments, smart contracts can be utilized for POs, particularly in contexts where automation, transparency, and contract enforcement are paramount. For example, in distributed-based systems, smart contracts can function as self-executing agreements, with the terms encoded directly into code. Such contracts, as tied to the disclosed systems and methods discussed herein, can offer several technical advantages for managing purchase orders.

According to some embodiments, for example, as discussed in more detail herein, the disclosed systems and methods can operate to automate the creation and execution process of the PO, thereby triggering the creation and issuance of a PO to a vendor once predefined conditions, such as approval, are met. Further, as discussed herein, the disclosed systems and methods can operate to monitor and enforce the terms of PO to automatically enable actions, such as, but not limited to, releasing payment to vendors upon the successful receipt and verification of goods or services, providing updates and/or progress of the timeline, modifying the PO and/or actions by a participating entity, and the like. This automation can lead to cost and time savings, streamlining procurement processes.

Accordingly, the disclosed systems and methods can function to provide a novel enterprise resource management framework (ERP) that can integrate seamlessly with existing procurement or ERP platforms and/or systems, thereby ensuring an accurate and efficient data exchange. Moreover, as evidenced from the instant disclosure, the framework's integration in the processing between entities enhances transparency and security in procurement operations, offering a modernized approach to supply chain management.

Moreover, while conventional systems' architecture and capabilities are tied to manual and reactive processes, the disclosed systems and methods provide an end-to-end (E2E) and/or business-to-business (B2B) management framework that is automated and predictive, which ensures a reduction in both real-world and digital resources in the curation of a PO, and completion of the PO processing, as discussed herein.

Accordingly, the disclosed framework can operate to provide real-time assessment and management of PO-based interactions (e.g., electronic transactions) between entities, and account for security, accuracy and efficiency parameters respective to both the transacting entities and the transactions themselves. Accordingly, the disclosed framework can ensure that real-time anomalous activities are accurately and timely detected, thereby preventing unsolicited and/or malicious activity from occurring via the real-time computational analysis of the transacting parties and their electronic interactions occurring therebetween.

Indeed, conventional mechanisms for monitoring electronic transactions are limited to checking or discerning whether a transaction is viable, proper, accurate and/or secure either before the transaction occurs or after its completion. This, however, leaves many holes (or “blind spots”) in the manner in which such electronic transactions can be secured.

To that end, according to some embodiments, the disclosed systems and methods provide a novel computerized framework that addresses such shortcomings, among others, by provided a “closed-loop” interactive system that integrates with the electronic entities performing or conducting an electronic transaction so as to provide end-to-end (E2E) assessments of the transaction. As provided for herein, the frameworks' thorough, real-time assessment of a transaction while it is occurring, in addition to its initial and conclusory assessment and analysis, can ensure that the viability, veracity and accuracy of the transacting parties is maintained, thereby enabling a resultant accurate and secure electronic transaction.

According to some embodiments, as discussed in more detail below, and by way of a non-limiting example, upon creation, the PO may undergo an electronic approval process, where designated approvers review and authorize the purchase based on predefined rules or thresholds. Once approved, the PO is transmitted electronically to the vendor, often utilizing electronic data interchange (EDI) or other electronic communication protocols for efficiency and accuracy. Throughout the procurement lifecycle, the PO is monitored electronically, with automated systems tracking key milestones such as order acknowledgment, shipment, and delivery. Any deviations or delays can be promptly flagged for resolution, ensuring adherence to procurement timelines and contractual obligations. Upon receipt of the goods or services, the details can be reconciled with the original PO. Thus, as discussed herein, reconciliation of the PO, in a real-time manner along each stage of transacting between entities is a vital component of the disclosed computerized procurement system, which can facilitate the efficient and transparent exchange of goods and services between entities (e.g., both in terms of real-world transacting and/or over a network, in a digital manner).

According to some embodiments, a method is disclosed for a DI-based computerized framework for monitoring and managing electronic interactions between contracting electronic entities. In accordance with some embodiments, the present disclosure provides a non-transitory computer-readable storage medium for carrying out the above-mentioned technical steps of the framework's functionality. The non-transitory computer-readable storage medium has tangibly stored thereon, or tangibly encoded thereon, computer readable instructions that when executed by a device cause at least one processor to perform a method for a DI-based computerized framework for monitoring and managing electronic interactions between contracting electronic entities.

In accordance with one or more embodiments, a system is provided that includes one or more processors and/or computing devices configured to provide functionality in accordance with such embodiments. In accordance with one or more embodiments, functionality is embodied in steps of a method performed by at least one computing device. In accordance with one or more embodiments, program code (or program logic) executed by a processor(s) of a computing device to implement functionality in accordance with one or more such embodiments is embodied in, by and/or on a non-transitory computer-readable medium.

### DESCRIPTIONS OF THE DRAWINGS

The features, and advantages of the disclosure will be apparent from the following description of embodiments as illustrated in the accompanying drawings, in which reference characters refer to the same parts throughout the various views. The drawings are not necessarily to scale, emphasis instead being placed upon illustrating principles of the disclosure:

FIG. 1 is a block diagram of an example configuration within which the systems and methods disclosed herein could be implemented according to some embodiments of the present disclosure;

FIG. 2 is a block diagram illustrating components of an exemplary system according to some embodiments of the present disclosure;

FIG. 3 illustrates an exemplary data flow according to some embodiments of the present disclosure;

FIG. 4 illustrates an exemplary data flow according to some embodiments of the present disclosure;

FIGS. 5A-5L depict non-limiting example embodiments according to some embodiment of the present disclosure;

FIG. 6 depicts an exemplary implementation of an architecture according to some embodiments of the present disclosure;

FIG. 7 depicts an exemplary implementation of an architecture according to some embodiments of the present disclosure; and

FIG. 8 is a block diagram illustrating a computing device showing an example of a client or server device used in various embodiments of the present disclosure.

### DETAILED DESCRIPTION

The present disclosure will now be described more fully hereinafter with reference to the accompanying drawings, which form a part hereof, and which show, by way of non-limiting illustration, certain example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

The present disclosure is described below with reference to block diagrams and operational illustrations of methods and devices. It is understood that each block of the block diagrams or operational illustrations, and combinations of blocks in the block diagrams or operational illustrations, can be implemented by means of analog or digital hardware and computer program instructions. These computer program instructions can be provided to a processor of a general purpose computer to alter its function as detailed herein, a special purpose computer, ASIC, or other programmable data processing apparatus, such that the instructions, which execute via the processor of the computer or other programmable data processing apparatus, implement the functions/acts specified in the block diagrams or operational block or blocks. In some alternate implementations, the functions/acts noted in the blocks can occur out of the order noted in the operational illustrations. For example, two blocks shown in succession can in fact be executed substantially concurrently or the blocks can sometimes be executed in the reverse order, depending upon the functionality/acts involved.

For the purposes of this disclosure a non-transitory computer readable medium (or computer-readable storage medium/media) stores computer data, which data can include computer program code (or computer-executable instructions) that is executable by a computer, in machine readable form. By way of example, and not limitation, a computer readable medium may include computer readable storage media, for tangible or fixed storage of data, or communication media for transient interpretation of code-containing signals. Computer readable storage media, as used herein, refers to physical or tangible storage (as opposed to signals) and includes without limitation volatile and non-volatile, removable and non-removable media implemented in any method or technology for the tangible storage of information such as computer-readable instructions, data structures, program modules or other data. Computer readable storage media includes, but is not limited to, RAM, ROM, EPROM, EEPROM, flash memory or other solid state memory technology, optical storage, cloud storage, magnetic storage devices, or any other physical or material medium which can be used to tangibly store the desired information or data or instructions and which can be accessed by a computer or processor.

For the purposes of this disclosure the term “server” should be understood to refer to a service point which provides processing, database, and communication facilities. By way of example, and not limitation, the term “server” can refer to a single, physical processor with associated communications and data storage and database facilities, or it can refer to a networked or clustered complex of processors and associated network and storage devices, as well as operating software and one or more database systems and application software that support the services provided by the server. Cloud servers are examples.

For the purposes of this disclosure a “network” should be understood to refer to a network that may couple devices so that communications may be exchanged, such as between a server and a client device or other types of devices, including between wireless devices coupled via a wireless network, for example. A network may also include mass storage, such as network attached storage (NAS), a storage area network (SAN), a content delivery network (CDN) or other forms of computer or machine-readable media, for example. A network may include the Internet, one or more local area networks (LANs), one or more wide area networks (WANs), wire-line type connections, wireless type connections, cellular or any combination thereof. Likewise, sub-networks, which may employ differing architectures or may be compliant or compatible with differing protocols, may interoperate within a larger network.

For purposes of this disclosure, a “wireless network” should be understood to couple client devices with a network. A wireless network may employ stand-alone ad-hoc networks, mesh networks, Wireless LAN (WLAN) networks, cellular networks, or the like. A wireless network may further employ a plurality of network access technologies, including Wi-Fi, Long Term Evolution (LTE), WLAN, Wireless Router mesh, or 2nd, 3rd, 4^{th} or 5^{th} generation (2G, 3G, 4G or 5G) cellular technology, mobile edge computing (MEC), Bluetooth, 802.11b/g/n, or the like. Network access technologies may enable wide area coverage for devices, such as client devices with varying degrees of mobility, for example.

In short, a wireless network may include virtually any type of wireless communication mechanism by which signals may be communicated between devices, such as a client device or a computing device, between or within a network, or the like.

A computing device may be capable of sending or receiving signals, such as via a wired or wireless network, or may be capable of processing or storing signals, such as in memory as physical memory states, and may, therefore, operate as a server. Thus, devices capable of operating as a server may include, as examples, dedicated rack-mounted servers, desktop computers, laptop computers, set top boxes, integrated devices combining various features, such as two or more features of the foregoing devices, or the like.

For purposes of this disclosure, a client (or user, entity, subscriber or customer) device may include a computing device capable of sending or receiving signals, such as via a wired or a wireless network. A client device may, for example, include a desktop computer or a portable device, such as a cellular telephone, a smart phone, a display pager, a radio frequency (RF) device, an infrared (IR) device a Near Field Communication (NFC) device, a Personal Digital Assistant (PDA), a handheld computer, a tablet computer, a phablet, a laptop computer, a set top box, a wearable computer, smart watch, an integrated or distributed device combining various features, such as features of the forgoing devices, or the like.

A client device may vary in terms of capabilities or features. Claimed subject matter is intended to cover a wide range of potential variations, such as a web-enabled client device or previously mentioned devices may include a high-resolution screen (HD or 4K for example), one or more physical or virtual keyboards, mass storage, one or more accelerometers, one or more gyroscopes, global positioning system (GPS) or other location-identifying type capability, or a display with a high degree of functionality, such as a touch-sensitive color 2D or 3D display, for example.

Certain embodiments and principles will be discussed in more detail with reference to the figures. According to some embodiments, the disclosed framework can provide users or practicing entities with a real-time risk detection platform, system and/or application that can proactively and interactively monitor electronic transactions as they are being initiated and performed. As discussed herein, in some embodiments, the disclosed framework can determine, extract, derive, predict or otherwise identify errors, risks and/or anomalies related to the transaction at various stages of the transactions' E2E life cycle. Accordingly, real-time assessments can be generated and provided for display/output that can accurately depict the integrity of the transaction, as well as the integrity of the transacting parties.

In some embodiments, as discussed infra, real-time notifications or alerts can be generated, which can enable interacting users, administrators, applications, and the like to view assessments of transaction activities and interact accordingly so as to identify the determined anomalies and act to remedy them in a seamless manner. In some embodiments, such notifications can be, but are not limited to, determined risk statistics, interactive electronic messages, graphs, charts, executable actions to remedy the risk/anomaly, and the like, as discussed in more detail below. Thus, the notification can provide reasonings as to why and/or how an anomaly is occurring, as well as determine metrics related to such reasonings. For example, the notification can include information indicating why a transaction is, but not limited to, inaccurate, incomplete, missing, fraudulent, and the like, and/or whether an involved entity/user is acting maliciously.

According to some embodiments, the disclosed framework can operate as middleware between transacting entities to ensure the proactive activity (e.g., initiation and/or onset of an electronic transaction), as well as the reactive (e.g., real-time) activity are monitored, checked and cured of anomalous information and/or events. Thus, upstream and/or downstream activity can be tracked and analyzed, which can be based on learned transaction behavior, as discussed below, whereby the disclosed framework can automate the modification, prevention/halting and/or completion of a transaction in a secure and efficient manner.

According to some embodiments, as discussed in more detail below, the determined risks, anomalies and/or events, for which notification and remedial action can be triggered, can include, but are not limited to, deviations from previous patterns (e.g., times, locations, routes and parties involved in a trade, for example; time between lifecycle events, seasonality and cyclical tendencies, and the like, by way of further example), comparison of transaction metrics (e.g., weight, volumes, prices, origin, lead time, committed delivery date, expected delivery date, and the like), available and/or determined metrics and data related to engaged devices and/or associated Internet of Things (IoT) devices, scan comparisons (e.g., digital twinning, for example, and/or other types of artificial intelligence/machine learning (AI/ML) algorithms, as discussed below), and/or other types of red flags related to criminal and/or malicious behavior, and the like, or some combination thereof.

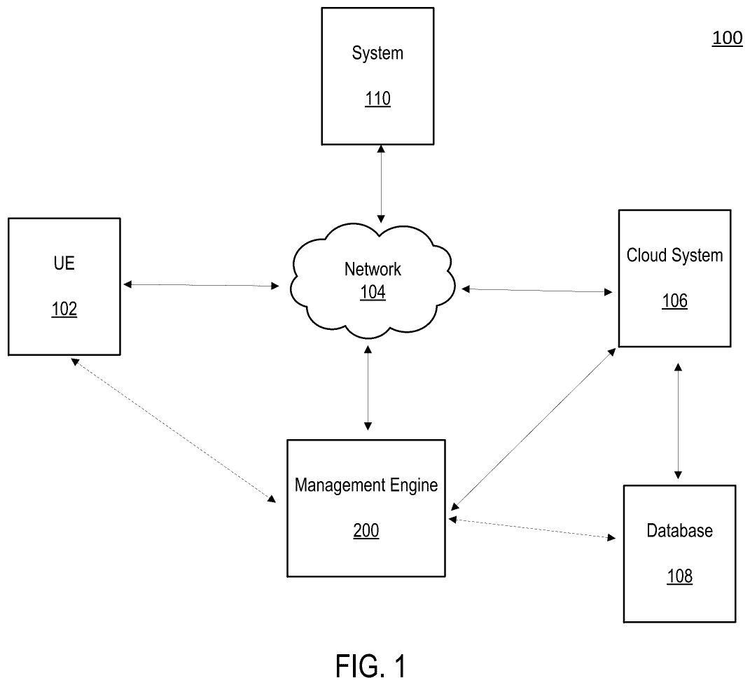

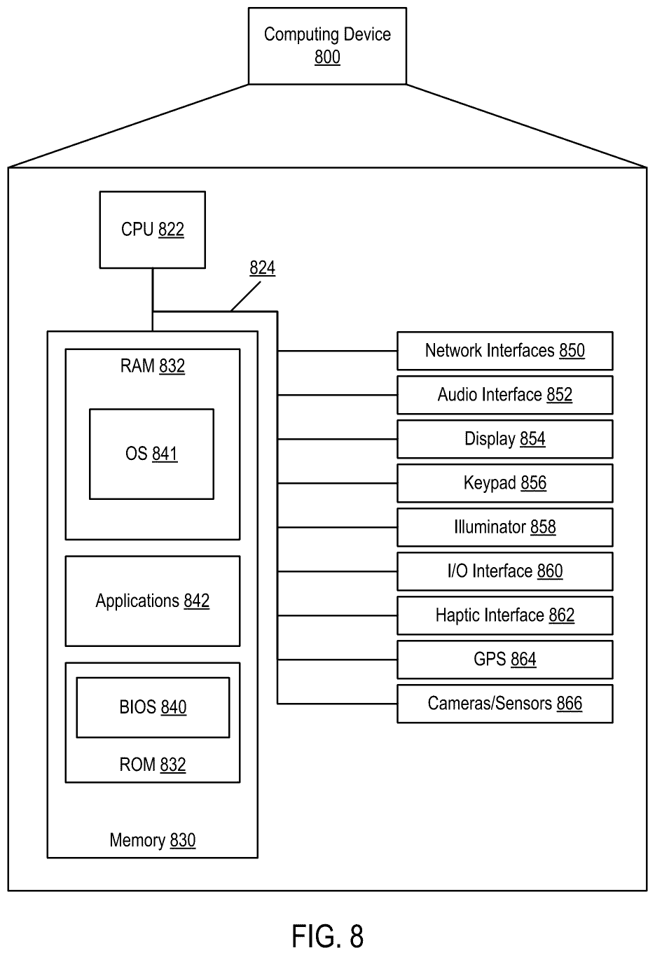

With reference to FIG. 1, system 100 is depicted which includes user equipment (UE) 102 (e.g., a client device, as mentioned above and discussed below in relation to FIG. 8), system 110, network 104, cloud system 106, database 108 and management engine 200.

It should be understood that while system 100 is depicted as including such components, it should not be construed as limiting, as one of ordinary skill in the art would readily understand that varying numbers of UEs, devices, users/entities, systems, cloud systems, databases and networks can be utilized; however, for purposes of explanation, system 100 is discussed in relation to the example depiction in FIG. 1.

According to some embodiments, UE 102 can be any type of device, such as, but not limited to, a mobile phone, tablet, laptop, Internet of Things (IoT) device, autonomous machine, and any other device equipped with functionality for connecting to a network and performing computational activities for interacting with other devices. In some embodiments, UE 102 can be a device associated with an individual (or set of individuals) for which transaction monitoring services are being provided. In some embodiments, UE 102 may correspond to a device of a company (e.g., corporation, for example), entity and/or person for which electronic business activity is being conducted.

According to some embodiments, system 110 can correspond to any type of device (or UE, as discussed above), computer system, electronic platform, web portal, electronically hosted network resource, and the like, or some combination thereof. In some embodiments, for example, system 100 can correspond to a third party UE for which a user of UE 102 is electronically interacting with to conduct business. In some embodiments, system 100 can correspond to an entity associated with a set of electronic, digital and/or real-world assets for which electronic transactions are being effectuated.

In some embodiments, network 104 can be any type of network, such as, but not limited to, a wireless network, cellular network, the Internet, and the like (as discussed above). Network 104 facilitates connectivity of the components of system 100, as illustrated in FIG. 1.

According to some embodiments, cloud system 106 may be any type of cloud operating platform and/or network based system upon which applications, operations, and/or other forms of network resources may be located. For example, system 106 may be a service provider and/or network provider from where services and/or applications may be accessed, sourced or executed from. For example, system 106 can represent the cloud-based architecture associated with a proprietary system provider, which has associated network resources hosted on the internet or private network (e.g., network 104), which enables (via engine 200) the risk and transaction management and monitoring discussed herein.

In some embodiments, cloud system 106 may include a server(s) and/or a database of information which is accessible over network 104. In some embodiments, a database 108 of cloud system 106 may store a dataset of data and metadata associated with local and/or network information related to a user(s) of UE 102/system 110 and the UE 102/system 110, and the services and applications provided by cloud system 106 and/or management engine 200.

In some embodiments, for example, cloud system 106 can provide a private/proprietary management platform, whereby engine 200, discussed infra, corresponds to the novel functionality system 106 enables, hosts and provides to a network 104 and other devices/platforms operating thereon.

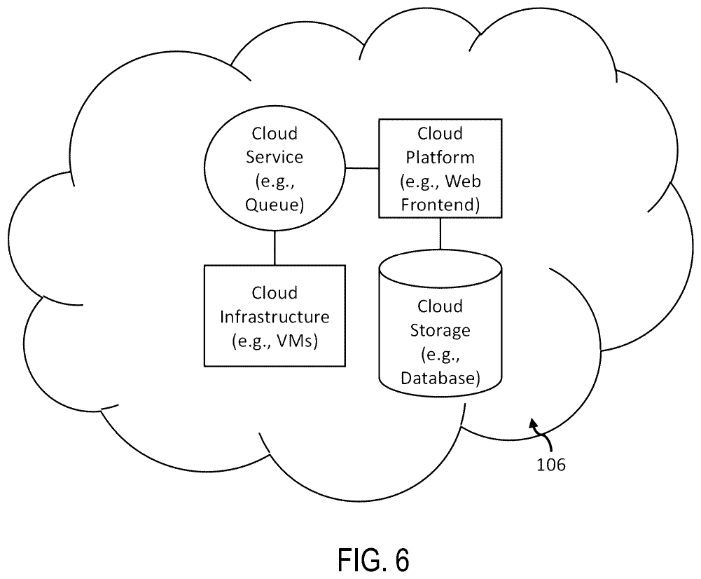

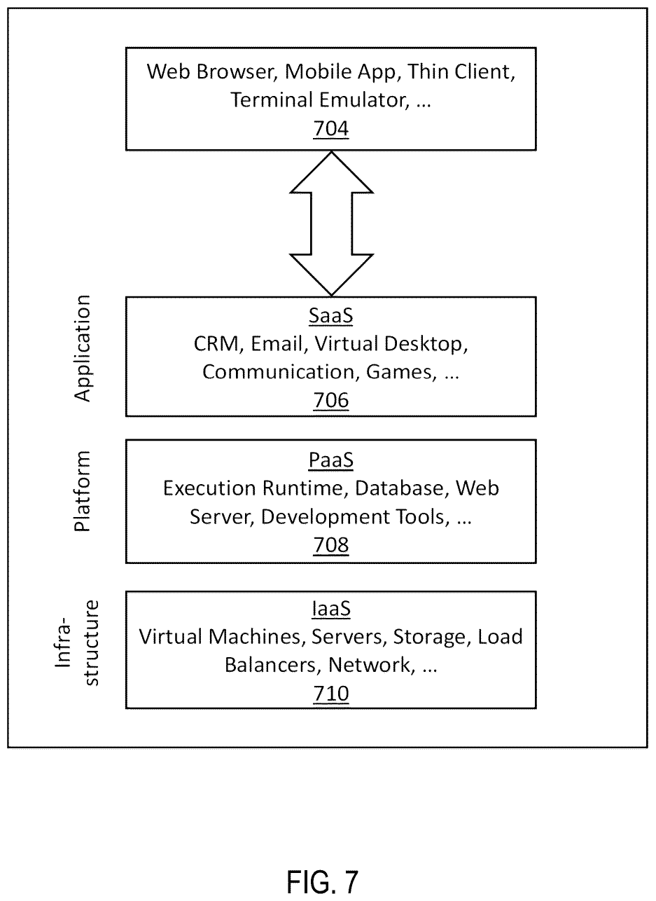

Turning to FIG. 6 and FIG. 7, in some embodiments, the exemplary computer-based systems/platforms, the exemplary computer-based devices, and/or the exemplary computer-based components of the present disclosure may be specifically configured to operate in a cloud computing/architecture 106 such as, but not limiting to: infrastructure a service (IaaS) 710, platform as a service (PaaS) 708, and/or software as a service (Saas) 706 using a web browser, mobile app, thin client, terminal emulator or other endpoint 704. FIG. 6 and FIG. 7 illustrate schematics of non-limiting implementations of the cloud computing/architecture(s) in which the exemplary computer-based systems for administrative customizations and control of network-hosted application program interfaces (APIs) of the present disclosure may be specifically configured to operate.

Turning back to FIG. 1, according to some embodiments, database 108 may correspond to a data storage for a platform (e.g., a network hosted platform, such as cloud system 106, as discussed supra) or a plurality of platforms. Database 108 may receive storage instructions/requests from, for example, engine 200 (and associated microservices), which may be in any type of known or to be known format, such as, for example, standard query language (SQL). According to some embodiments, database 108 may correspond to any type of known or to be known storage, for example, a memory or memory stack of a device, a distributed ledger of a distributed network (e.g., blockchain, for example), a look-up table (LUT), and/or any other type of secure data repository

Management engine 200, as discussed above and further below in more detail, can include components for the disclosed functionality. According to some embodiments, management engine 200 may be a special purpose machine or processor, and can be hosted by a device on network 104, within cloud system 106 and/or on UE 102. In some embodiments, engine 200 may be hosted by a server and/or set of servers associated with cloud system 106.

According to some embodiments, as discussed in more detail below, management engine 200 may be configured to implement and/or control a plurality of services and/or microservices, where each of the plurality of services/microservices are configured to execute a plurality of workflows associated with performing the disclosed risk and transaction management. Non-limiting embodiments of such workflows are provided below.

According to some embodiments, as discussed above, management engine 200 may function as an application provided by cloud system 106. In some embodiments, engine 200 may function as an application installed on a server(s), network location and/or other type of network resource associated with cloud system 106. In some embodiments, engine 200 may function as an application installed and/or executing on UE 102. In some embodiments, such application may be a web-based application accessed by UE 102 and/or devices over network 104 from cloud system 106. In some embodiments, engine 200 may be configured and/or installed as an augmenting script, program or application (e.g., a plug-in or extension) to another application or program provided by cloud system 106 and/or executing on UE 102.

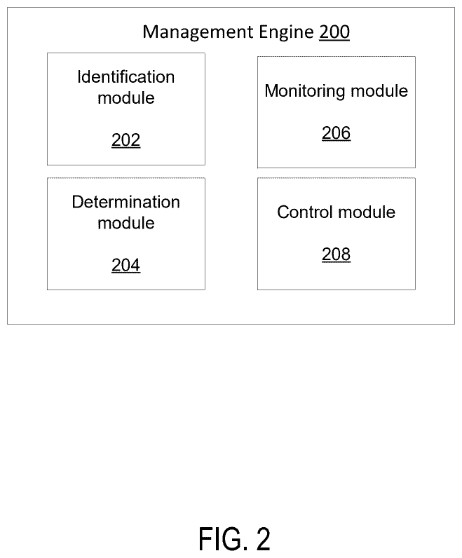

As illustrated in FIG. 2, according to some embodiments, management engine 200 includes identification module 202, determination module 204, monitoring module 206 and control module 208. It should be understood that the engine(s) and modules discussed herein are non-exhaustive, as additional or fewer engines and/or modules (or sub-modules) may be applicable to the embodiments of the systems and methods discussed. More detail of the operations, configurations and functionalities of engine 200 and each of its modules, and their role within embodiments of the present disclosure will be discussed below.

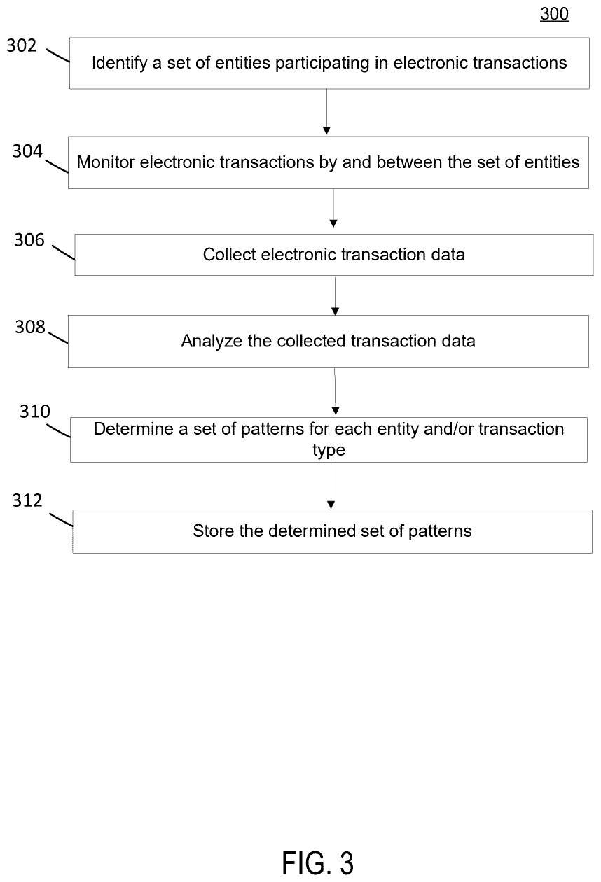

Turning to FIG. 3, Process 300 provides non-limiting example embodiments for the disclosed risk management framework. According to some embodiments, Steps 302-306 of Process 300 can be performed by identification module 202 of management engine 200; and Steps 308-312 can be performed by determination module 204.

According to some embodiments, Process 300 begins with Step 302 where a set of entities participating in electronic transactions are identified. In some embodiments, for example, such entities can include, but are not limited to, users (e.g., traders), companies, organizations, businesses, platforms, exchanges, applications, and the like.

In some embodiments, Step 302 can involve the identification of data/metadata related to such entities, including, but not limited to, identifier (ID), location, type of entity, types of transactions, types of platforms used for transactions, frequency of transacting, experience level of transacting, size, types of assets traded, account information, and the like, or some combination thereof.

In Step 304, engine 200 can monitor electronic transactions by and between the set of entities. Such monitoring can be in accordance with a criteria, which can correspond to, but not be limited to, a time, date, location, type of entity, type of transaction, price, quantity, delivery date, and the like.

In some embodiments, for example, such monitoring can be performed continuously for a time period and/or periodically (according to a threshold time iteration) for a time period. For example, electronic transactions between entity A and B can be continuously tracked for type Y transactions that involve Z assets For a predetermined number of months (e.g., 3 months, for example).

Accordingly, in Step 306, based on the monitoring in Step 304, engine 200 can collect electronic transaction data. Such electronic transaction data can include information related to, but not limited to, ID of entity/user transacting with other entities/users, types of transactions, assets of transactions, volume/size of transactions, date, time, location, type of assets, and the like, or some combination thereof.

Moreover, in some embodiments, the data can indicate and/or correspond to, but not be limited to, supplier proposed changes (e.g., date change, quantity change, price change, cancellation, splits, and the like), shipment status (e.g., ready to ship, shipment delays, shipment complete, shipment lost, and the like), delivery status (e.g., “due soon,” late, lost, and the like), communication issues (e.g., supplier email issues, email notification issues, and the like), and the like, or some combination thereof.

In some embodiments, the collected electronic transaction data in Step 306 can be stored in database 108 in association with an identifier (ID) of an entity (or entities), asset type, type of transaction, and the like, or some combination thereof.

In Step 308, engine 200 can analyze the collected electronic transaction data. According to some embodiments, engine 200 can implement any type of known or to be known computational analysis technique, algorithm, mechanism or technology to analyze the collected electronic transaction data from Step 306.

In some embodiments, engine 200 may include a specific trained artificial intelligence/machine learning model (AI/ML), a particular machine learning model architecture, a particular machine learning model type (e.g., convolutional neural network (CNN), recurrent neural network (RNN), autoencoder, support vector machine (SVM), and the like), or any other suitable definition of a machine learning model or any suitable combination thereof.

In some embodiments, engine 200 may be configured to utilize one or more AI/ML techniques chosen from, but not limited to, computer vision, feature vector analysis, decision trees, boosting, support-vector machines, neural networks, nearest neighbor algorithms, Naive Bayes, bagging, random forests, logistic regression, and the like.

In some embodiments and, optionally, in combination of any embodiment described above or below, a neural network technique may be one of, without limitation, feedforward neural network, radial basis function network, recurrent neural network, convolutional network (e.g., U-net) or other suitable network. In some embodiments and, optionally, in combination of any embodiment described above or below, an implementation of Neural Network may be executed as follows:
a. define Neural Network (NN) architecture/model (e.g., define layers of NN as to a feature engineering pipeline),
b. transfer the input data to the neural network model,
c. train the model incrementally,
d. determine the accuracy for a specific number of timesteps,
e. apply the trained model to process the newly-received input data,
f. optionally and in parallel, continue to train the trained model with a predetermined periodicity.

In some embodiments and, optionally, in combination with any embodiment described above or below, the trained neural network model may specify a neural network by at least a neural network topology, a series of activation functions, and connection weights. For example, the topology of a neural network may include a configuration of nodes of the neural network and connections between such nodes. In some embodiments and, optionally, in combination of any embodiment described above or below, the trained neural network model may also be specified to include other parameters, including but not limited to, bias values/functions and/or aggregation functions. For example, an activation function of a node may be a step function, sine function, continuous or piecewise linear function, sigmoid function, hyperbolic tangent function, or other type of mathematical function that represents a threshold at which the node is activated. In some embodiments and, optionally, in combination of any embodiment described above or below, the aggregation function may be a mathematical function that combines (e.g., sum, product, and the like) input signals to the node. In some embodiments and, optionally, in combination of any embodiment described above or below, an output of the aggregation function may be used as input to the activation function. In some embodiments and, optionally, in combination of any embodiment described above or below, the bias may be a constant value or function that may be used by the aggregation function and/or the activation function to make the node more or less likely to be activated.

In Step 310, based on the analysis from Step 308, engine 200 can determine a set of patterns that corresponds to the set of entities (and/or in some embodiments, an asset ID, asset type and/or transaction type, for example). According to some embodiments, the determined patterns are based on the computational AI/ML analysis performed via engine 200, as discussed above.

In some embodiments, such patterns can include information related to, but not limited to, lead time risk, missing acknowledgement, “On Time In Full” (OTIF) risk, short risk, and the like. Such indications can be provided as data/metadata within each pattern. For example, entity X typically operates its procurement activities with an OTIF risk at or below a threshold, which satisfies an accuracy threshold (e.g., 95% for example) (also referred to as a “risk appetite,” for example).

In some embodiments, the set of patterns can correspond to, but are not limited to, types of entities, types of assets, types of activity/transactions, time, date, duration, platform for transacting, and the like, or some combination thereof.

In Step 312, engine 200 can store the determined set of patterns in database 108, in a similar manner as discussed above. According to some embodiments, Step 312 can involve creating a data structure associated with each determined pattern, whereby each data structure can be stored in a proper storage location associated with an associated user/entity ID, as discussed above.

In some embodiments, a pattern can comprise a set of events, which can correspond to, but not be limited to, the commencement of the transaction, intermediate stages of the transaction and conclusion of the transaction, upon which information related to compliance with rules/regulations can be identified, as well as information related to detected events (e.g., successes and/or anomalies) within each stage. In some embodiments, the data structure for a pattern can be relational, in that the events of a pattern can be sequentially ordered, and/or weighted so that the order corresponds to events with more, less or no anomalous/risk-based activity.

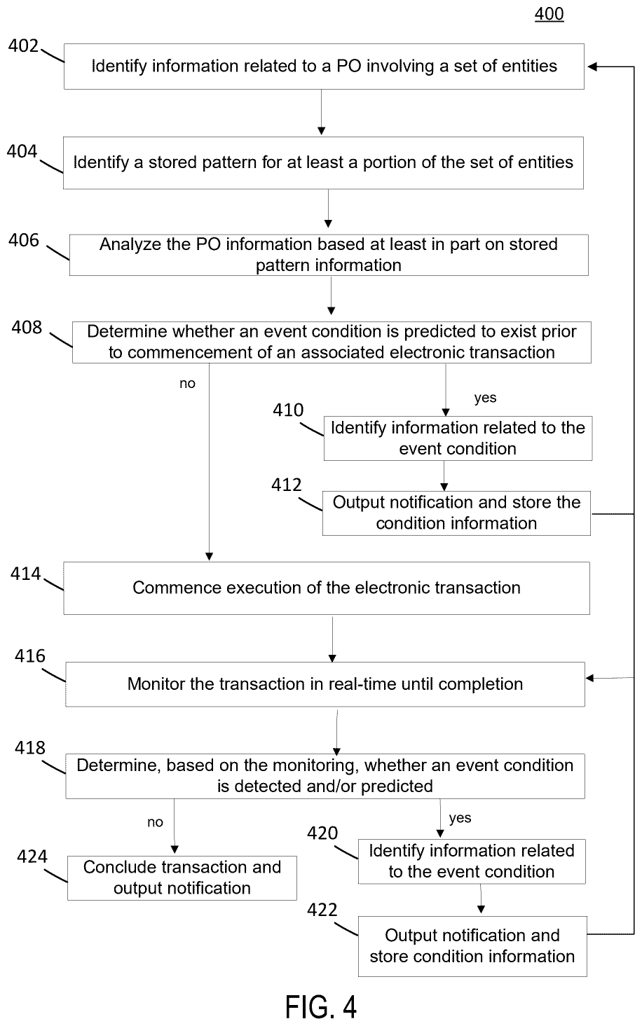

In some embodiments, the structure of the data structure for a pattern can enable a more computationally efficient (e.g., faster) search of the pattern to determine if later detected events correspond to the events of the pattern, as discussed below in relation to at least Steps 404-408 of Process 400 of FIG. 4.

In some embodiments, the data structures of patterns can be, but are not limited to, files, arrays, lists, binary, heaps, hashes, tables, trees, and the like, and/or any other type of known or to be known tangible, storable digital asset, item and/or object.

According to some embodiments, the electronic transaction data can be identified and analyzed in a raw format, whereby upon a determination of the pattern, the data can be compiled into refined data (e.g., a format capable of being stored in and read from database 108). Thus, in some embodiments, Step 312 (and/or Step 310) can involve the creation and/or modification (e.g., transformation) of the electronic transaction data into a storable format.

In some embodiments, as discussed below, each pattern (and corresponding data structure) can be modified based on further detected behavior, as discussed below in relation to Process 400 of FIG. 4.

Turning to FIG. 4, Process 400 provides non-limiting example embodiments for the deployment and/or implementation of the disclosed framework.

According to some embodiments, as discussed herein, monitoring a purchase order (PO) throughout its processing stages can significantly improve the likelihood of successful completion, even in the face of potential risks detected during intermediate stages. By implementing a robust monitoring system, as discussed herein, the disclosed framework can enable entities (or organizations) to proactively identify and address issues as they arise, preventing them from escalating into larger problems that could derail the procurement process. For example, if there are delays in vendor acknowledgment or shipment, automated alerts triggered by the monitoring system can prompt stakeholders to intervene promptly, ensuring that the PO stays on track. Moreover, continuous monitoring allows for real-time visibility into the status of the PO, enabling stakeholders to identify bottlenecks or inefficiencies and take corrective action promptly. Additionally, by monitoring key milestones such as, for example, delivery dates and receipt of goods, entities can anticipate and mitigate risks related to late deliveries or quality issues, thereby safeguarding against disruptions to operations.

Accordingly, as discussed herein, by leveraging monitoring mechanisms throughout the processing of a PO, the disclosed framework can enable entities to enhance their ability to navigate potential risks and ensure the timely and successful completion of procurement activities. Indeed, the disclosed framework can mitigate the impact of such risks by performing corrective actions earlier than allowed by traditional risk detection systems, as discussed herein.

According to some embodiments, Steps 402 and 416 of Process 400 can be performed by monitoring module 206 of management engine 200; Step 404 can be performed by collection module 202; Steps 406-410 and 416-420 can be performed by determination module 204; and Steps 412-414 and 422-424 can be performed by control module 208.

According to some embodiments, Process 400 begins with Step 402 where engine 200 identifies information related to a PO that involves a set of entities. For example, as discussed above, the PO can correspond to a request between a set of entities (e.g., two companies, for example) that are to be transacting business (e.g., electronic transaction).

As discussed herein, the PO and/or corresponding electronic transaction can be configured as data structure and/or an executable and/or electronic file or set of instructions defined within an electronic data structure. In some embodiments, such PO can correspond to a first stage or commencement/initiation of the electronic file or data structure (e.g., first stage of the transaction). In some embodiments, Step 402 can involve the identification of transaction information, in a similar manner as discussed above, which can include, but is not limited to, ID of the entities/users in the transaction, transaction type, asset information involved in the transaction (e.g., type and quantity of assets, for example), time, date, and the like.

In Step 404, based on the identified information from the PO from Step 402, engine 200 can retrieve, extract, search for and identify, or otherwise identify a stored pattern(s). The stored pattern can correspond to transaction pattern information for the entities of the transaction, for example, as discussed above.

In Step 406, engine 200 can analyze the PO information from the transaction request (e.g., the transaction information) based on the stored pattern information. According to some embodiments, such analysis can be performed via execution of the AI/ML models discussed above.

In Step 408, based on the analysis of Step 406, engine 200 can perform a determination as to whether an event condition exists prior to execution of the electronic transaction.

According to some embodiments, before the initiation of a transaction tied to a PO between entities, various conditions can be monitored (and/or potentially mitigated, as discussed infra) that could hinder the transaction's success. Risks may encompass several areas, including, but not limited to, agreement on terms and conditions, budget approval, vendor selection, product or service specifications, legal and regulatory compliance, approval workflows, financial considerations, risk assessment, and the like. Such risks can be tied to a supply, means for transmitting assets, ability to accept the assets, man-power, computing power and/or facilities for processing the assets (both physically and/or digitally in the buyer, vendor and/or supplier's databases, for example), and the like.

By way of some non-limiting examples: failure to reach consensus on terms and conditions may lead to misunderstandings or disputes during the transaction; insufficient budget approval could result in funding shortages, delaying or halting the procurement process; inadequate vendor selection may lead to unreliable suppliers, compromising product or service quality and delivery timelines; undefined or ambiguous product specifications increase the risk of receiving goods or services that do not meet expectations; non-compliance with legal and regulatory requirements may result in fines, legal disputes, or reputational damage; complex approval workflows may prolong transaction times and increase administrative burdens; financial considerations, such as inadequate funding or budget mismanagement, may disrupt cash flow and delay payments to vendors; failure to assess and mitigate risks, including supply chain disruptions or financial instability of vendors, may jeopardize the transaction's success and overall business operations, and the like.

In some embodiments, for example, such events may correspond to the absence of information, which may refer to, but is not limited to, an item, task and/or operation not being included and/or identified within the PO, information deviating from the pattern for an entity, and the like, or some combination thereof.

Accordingly, as discussed herein, engine 200 can identify and address such risks, inter alia, before initiating transactions (and during such transactions, as discussed infra) and thereby enhance the procurement processes of each entity's efficiency, compliance, and resilience.

According to some embodiments, as discussed above, such determination can be based on and/or involve, inter alia, deviations from previous patterns (e.g., times, locations, routes, types of parties involved, quantities of parties involved, and the like, for example), comparison of transaction metrics (e.g., weight, volumes, prices, origin, and the like), determined metrics and data related to engaged devices and/or associated IoT devices, scan comparisons, and/or other types of red flags related to criminal and/or malicious behavior, and the like, or some combination thereof. Indeed, such determination can correspond to, in addition to the above determinations, whether the regulatory compliance applicable to the specific transaction is being properly adhered to (California Consumer Privacy Act (CCPA), General Data Protection Regulation (GDPR), Health Insurance Portability and Accountability Act (HIPAA), and the like).

According to some embodiments, when engine 200, in Step 408, determines that an event condition associated with the transaction is present prior to commencement of the electronic transaction, processing can proceed from Step 408 to Step 410.

In Step 410, engine 200 can extract, determine, derive or otherwise identify the information related to the condition. Such condition information can correspond to and/or be based on the PO information from Step 402, in that the information includes data that relates to an error, anomaly or other form of mis-information or improper activity involved in the commencement of the transaction. For example, the number assets in the agreed upon contract are not being flagged or queued for a transfer; therefore, such error can be detected via the analysis of the participating entities workflow prior to the engagement/commencement of the transaction (e.g., as a first stage of the electronic transaction).

In Step 412, upon identifying the information related to the event condition, as in Step 410, engine 200 can compile, generate and output a notification and store the information related to the event condition. According to some embodiments, the notification can be configured as, but not limited to, text, audio, video, multi-media, and the like, or some combination thereof. In some embodiments, for example, the notification can be configured as a statistical dashboard that indicates a level or risk (e.g., high, medium or low, for example). For example, a graphical output can be compiled that indicates a percentage of likelihood that the transaction includes at least one anomaly. In another example, the output of the notification can provide interactive interface (IOs) that can indicate which components of the electronic transaction are deficient, whereby upon their display within a dashboard (or other form of user interface (UI)), detailed information about such components can be retrieved. This, therefore, enables the notification to be displayed, then subsequently modified and/or interacted with so as to provide the necessary parties opportunities to remedy the event condition.

In some embodiments, the dashboard can be leveraged to determine whether the electronic transaction can proceed. That is, levels of risk (e.g., high, medium or low) that correspond to threshold levels/ranges of anomalies, as discussed herein, may be identified and by-passed, thereby enabling specific stages of the transaction to continue despite an identified potential pitfall during a particular stage. For example, if an event is identified as a “low risk” (e.g., a number of assets pegged for trade is off but only be a certain threshold percentage), then this can be identified, and the corresponding notification can be output; however, the transaction can continue because the anomaly determined may not be a type, value or component that could prevent completion of the transaction to a pre-agreed upon term/agreement.

Indeed, in some embodiments, a frequency, number or some combination thereof of particular types of events (e.g., high, medium or low risk) may compound can cause certain stages to be halted, as discussed herein. For example, if one low risk anomaly is identified, this may still enable the stage/transaction to proceed; however, if n low risk anomalies are identified for the transaction, for a stage or subset of stages, with n being at or above a threshold number of anomalies, then the transaction may be halted and/or restarted, as discussed herein.

In some embodiments, the notification can be electronically communicated (e.g., as a message for display) to the entity involved in the electronic transaction that is responsible for the event condition, can be communicated to both parties of the transaction, to a third party overseeing the transaction, and the like, or some combination thereof. In some embodiments, the notification can include functionality that enables the event condition to be corrected, which can involve a computer-generated suggestion that can modify the operations of the entity responsible for the event condition.

In some embodiments, the notification can include a recommendation to fix, mitigate and/or address the detected risk. For example, engine 200 can, via the AI/ML analysis discussed herein, determine the risk factors, and based on understanding the PO information (from Step 402, inter alia) determine what each entity is capable of doing to cure the current risk conditions. For example, move back the delivery date when current delivery is being halted by inclement weather. In some embodiments, such notification can be sent to an entity in the transaction, which can enable the entity to provide their own recommendation for mitigation—for example, move back delivery k days. In some embodiments, one or both notifications/recommendations can be provided for display and/or curation of the condition, as discussed herein.

In some embodiments, recommended solutions can be determined that related to a “best action” to resolve a risk”, which can be performed by the AI/ML models discussed above, or a separate model executed by engine 200

In some embodiments, as indicated in FIG. 4, via the line from Step 412 to Step 402, engine 200 can re-process updates, corrections and/or modifications to the electronic transaction prior to its commencement. As such, upon such updating, Steps 402-408 can be recursively performed to check whether such updates comply with the governing rules and/or requirements of the electronic transaction.

In some embodiments, when engine 200 determines that no event (or risk) conditions are present or detected (e.g., the terms of the transaction comply with regulatory terms and other term sheets, as well as the agreed upon assets are flagged for transfer, for example), engine 200 can proceed from Step 408 to Step 414.

In Step 414, engine 200 can proceed with the electronic transaction. That is, upon the commencement (e.g., first stage) being approved/satisfied (e.g., via Step 408), the asset transfer and corresponding workflows defined by each entity according to the PO can begin (e.g., according to a schedule defined by the data structure of the PO, which as discussed below can be analyzed and/or modified to case the data structure to be modified in the manner it executes). According to some embodiments, the corresponding subsequent stages of the electronic transaction (e.g., second stage, third stage, . . . n-stage, until the conclusory stage) can be monitored via the processing performed in Step 416. According to some embodiments, stages of the electronic transaction can correspond to workflows of each entity that are to be performed to comply with and perform the electronic transaction. For example, enable access to accounts, provide privileged documents, identify assets, enable inspection, provide electronic funds, begin processing and/or manufacture of assets, lock in particular prices at particular times, and the like, or some combination thereof (e.g., any type of transaction activity corresponding to digital, electronic and/or real-world assets).

Accordingly, in some embodiments, engine 200 can perform monitoring of each stage of the transaction in real-time as each stage progresses. As discussed above, such monitoring can be performed continuously and/or according to a predetermined time period or event within a particular stage (e.g., transfer of a number of assets, transfer of electronic funds, access to particular accounts, and the like).

In Step 418, engine 200 can (e.g., for each stage of the electronic transaction) analyze the activity of each entity involved in the electronic transaction (e.g., their workflow, for example), and determine whether an event condition is detected, determined, predicted to arise, or otherwise be identified. Accordingly, engine 200 can perform Step 418 in a similar manner as discussed above at least in relation to Steps 404-408. For example, stored activity behavior for a particular entity, particular asset and/or particular stage of an electronic transaction can be analyzed via current/real-time activity of a respective stage via AI/ML model execution, as discussed supra.

Accordingly, in some embodiments, when an event condition is identified, processing can proceed from Step 418 to Step 420, whereby information related to the event condition can be identified. In Step 422, an output notification can be generated and the information related to the event condition can be stored in database 108. According to some embodiments, Steps 420 and 422 can be performed in a similar manner as discussed above at least in relation to Steps 410 and 412 (e.g., the compiled notifications and/or recommendations, among other features described with reference to Step 412, supra).

Moreover, processing can recursively proceed to Step 402. In some embodiments, the electronic transaction can be halted, such that the updated/modifications can be performed. In some embodiments, upon updating the transaction, Process 400 can be recursively performed to enable continued processing and monitoring from the stage where the event activity was detected (as indicated via the loop-back from Step 422 to Step 416. In some embodiments, based on a type of anomaly and/or type of transaction, the entirety of the transaction may be required to be re-performed (as indicated via the loop-back to Step 402 from Step 422).

In some embodiments, such recursive processing can involve modifying the PO, such that certain terms and/or other forms of data and/or metadata within the PO can be altered and/or updated to mitigate the detected event risk. For example, if the PO identified an incorrect amount of assets (e.g., which can be detected in Step 418 (or, in some embodiments, in Step 408, discussed supra)), engine 200 can function to update the number of assets to mitigate/address the event condition. Thus, the initial PO can be modified, such that a modified PO data structure is curated and saved in database 108 for the subsequent processing via the steps of Process 400.

According to some embodiments, the processing discussed herein related to Steps 418-422 can involve functionality for modifying a sequence or order of operations related to the transaction defined within the current version of the PO. For example, a PO may involve a set of tasks, and if the first task has an error, yet the second and third tasks do not, and their operation is not contingent on the first task, they can be prioritized over the first task. Thus, such tasks can be completed, then engine 200 can recursively proceed to prior steps of Process 400 to address the risk in the first task.

Accordingly, in some embodiments, upon the detection of certain risks associated with a task, information and/or stage associated with PO, prioritization of tasks becomes crucial to mitigate potential negative impacts on the transaction. Different risks may necessitate different prioritization strategies to ensure the smooth execution of the procurement process. For example, if engine 200 detects risks related to delayed delivery due to supply chain disruptions, prioritizing tasks related to alternative sourcing or expedited shipping options may be necessary to ensure timely receipt of goods. Similarly, if engine 200 detects conditions of risk related to product quality or compliance with specifications, prioritizing tasks related to quality assurance, supplier audits, or renegotiating terms with the vendor may be essential to prevent potential issues down the line.

Moreover, for example, financial risks, such as budget overruns or payment delays, may require prioritizing tasks related to financial planning, budget reallocation and/or negotiations with stakeholders to secure additional funds. In another example, a financial risk can involve delayed revenue recognition or disrupted sale orders, which can be identified upstream at the onset of the processing of the PO (discuss supra), during the processing and/or upon completion, as discussed herein. Additionally, if there are legal or regulatory risks associated with the transaction, engine 200 can prioritize tasks related to compliance reviews, contract revisions, or obtaining legal counsel may be necessary to mitigate legal liabilities.

Thus, via engine 200's monitoring and real-time auditing of the stages/tasks of a transaction, engine 200 can function to diverge from the initial sequence of operations defined by PO to prioritizing certain tasks based on the specific risks identified, which can enable entities to can effectively allocate resources and address critical issues promptly, minimizing the potential impact on the PO and ensuring its successful completion.

According to some embodiments, upon the completion of the electronic transaction without detection of an event condition (e.g., as per performing the transaction without any detected risk, performing the transaction upon fixing a risk and/or prioritizing certain tasks to obviate a risk, as discussed herein, for example), engine 200 can proceed from Step 418 to Step 424, such that an output notification is generated and displayed. The notification can involve an indication of completion of the transaction, and can be sent to each entity involved in the electronic transaction, a third party, a platform, published to a network location, and the like, or some combination thereof. In some embodiments, the notification can function similar to the notification discussed above in relation to Step 412.

According to some embodiments, information related to the steps in Process 400 (e.g., the determinations in Steps 408 and 418, identified information in Steps 410 and 420, and the information related to the electronic transaction from Steps 402 and 416) can be stored in database 108, as discussed above. In some embodiments, such information can be utilized to store and/or update patterns of activity in a similar manner as discussed in relation to Process 300 of FIG. 3, supra.

According to some embodiments, an entity, set of entities, type of transaction, type of asset, and the like, or some combination thereof, can have a dedicated engine 200 model so that the assessment protocols applied to an electronic transaction can be specific to the events and patterns learned and detected for that type of electronic transaction.

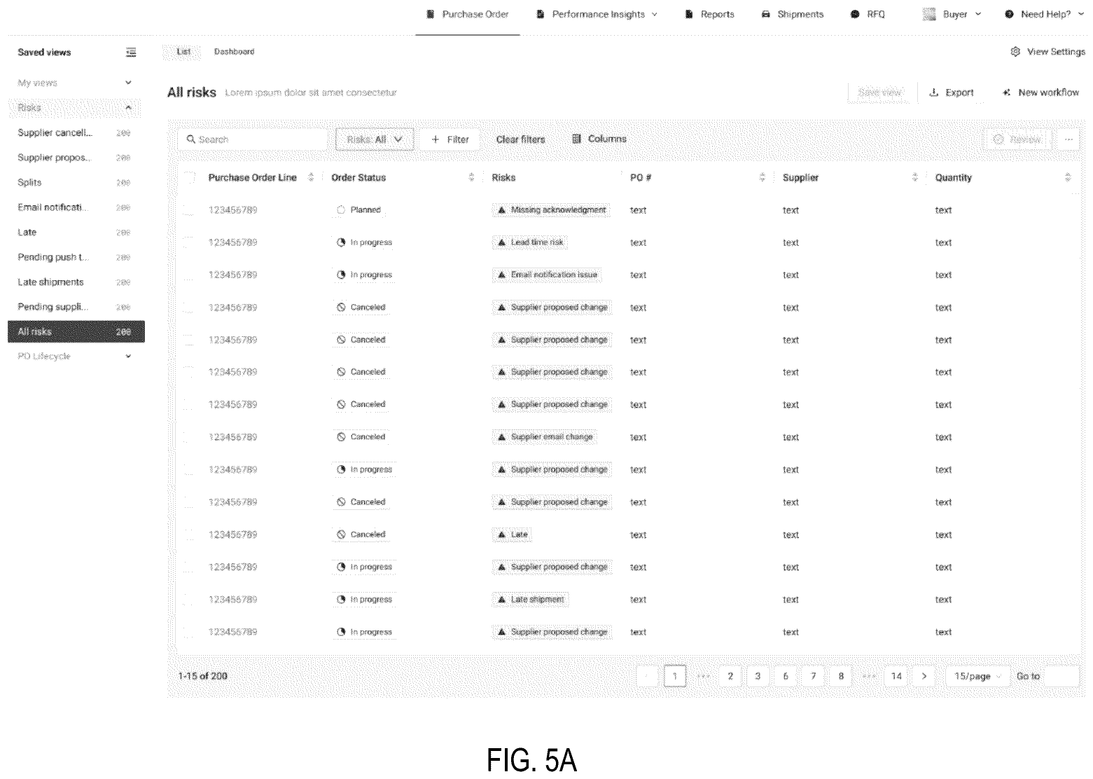

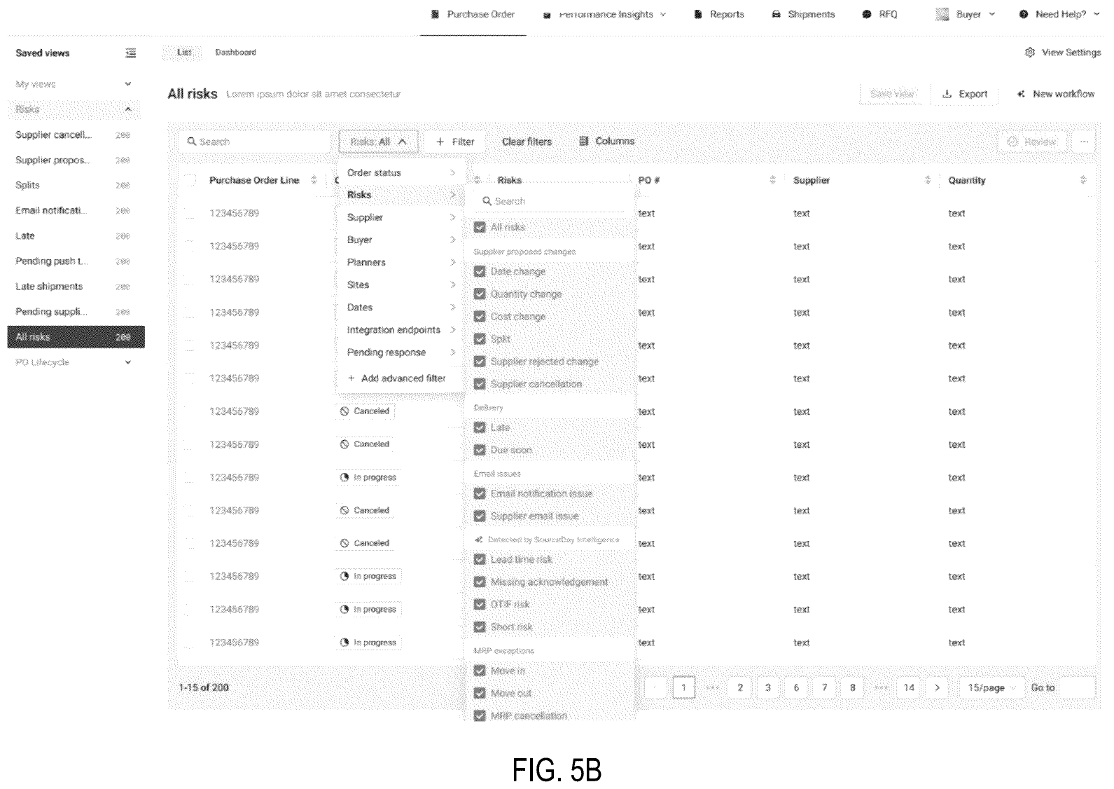

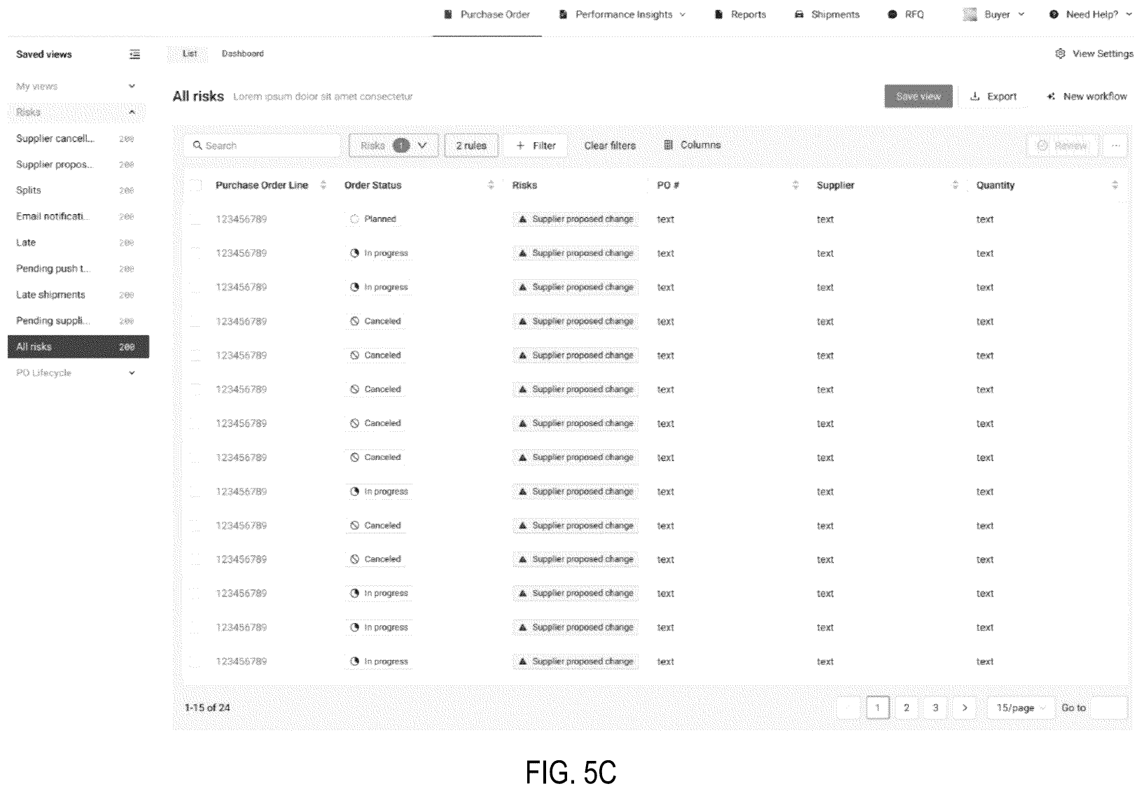

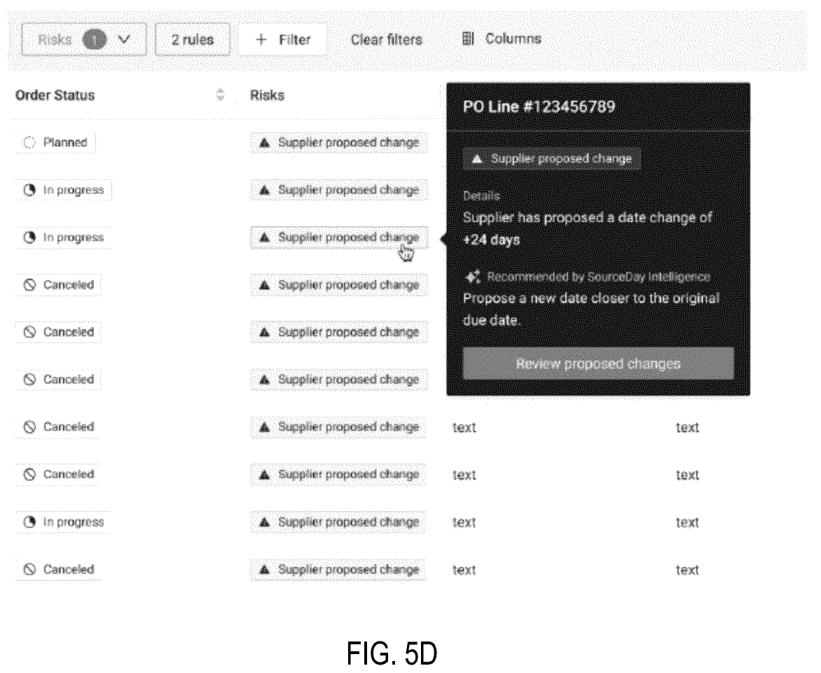

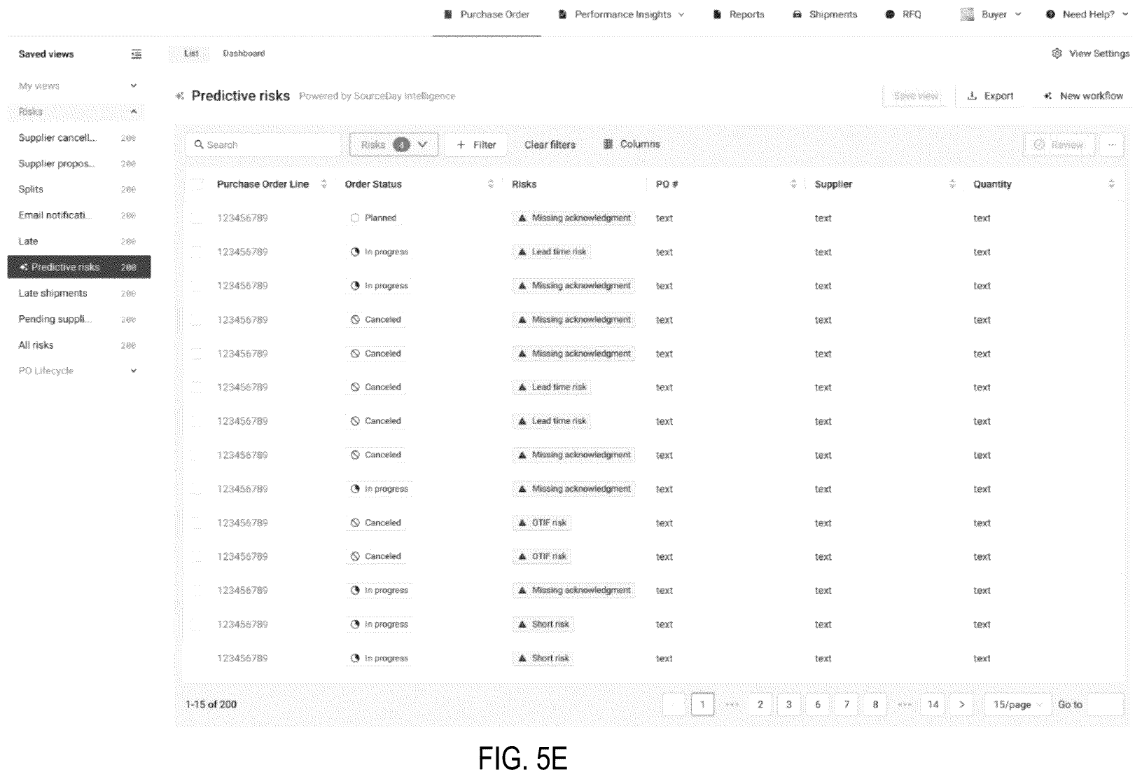

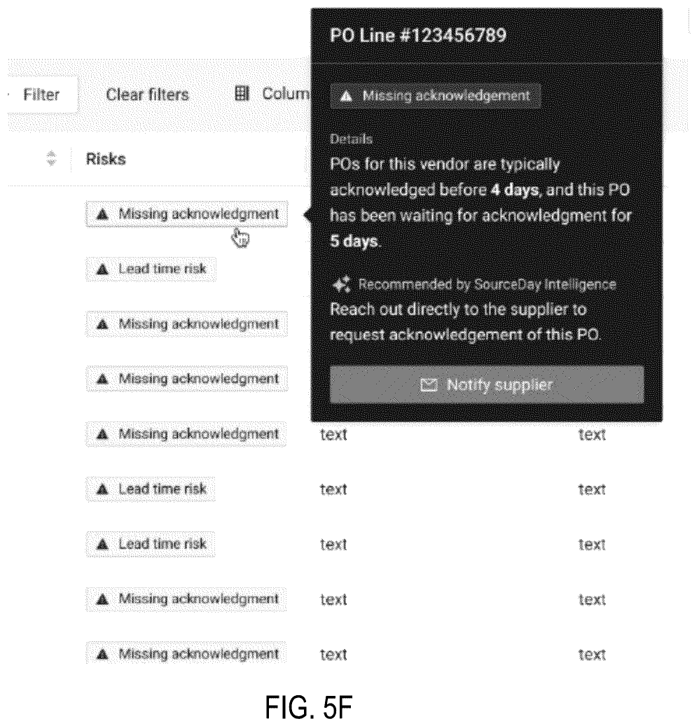

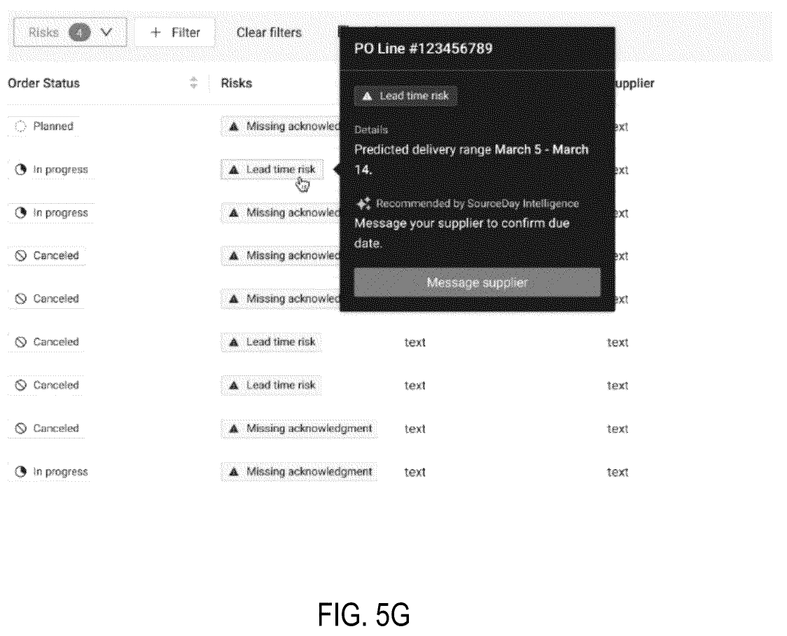

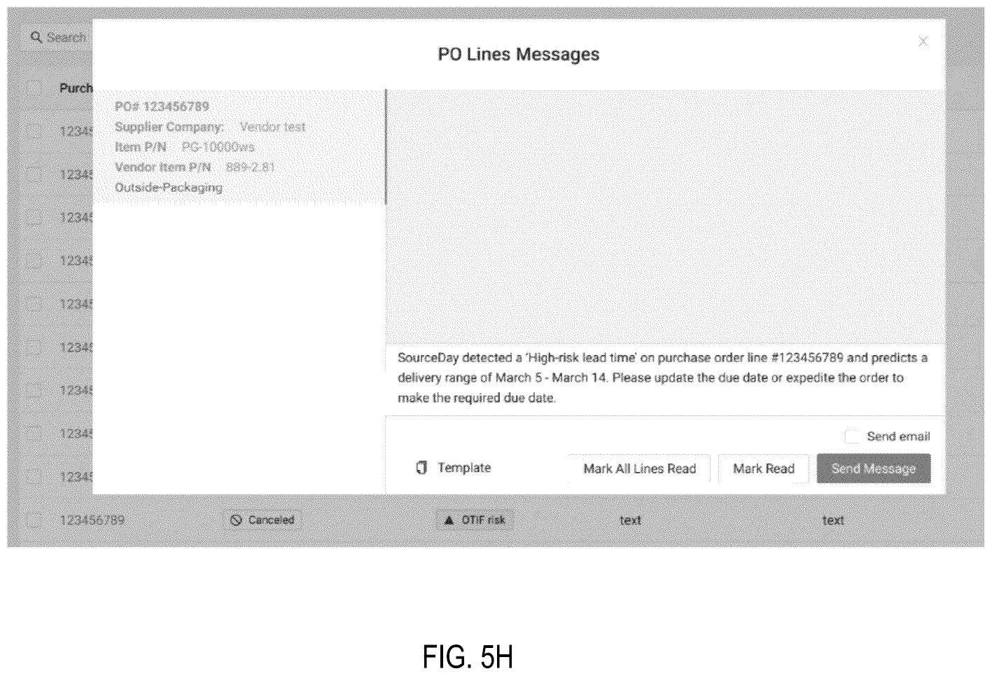

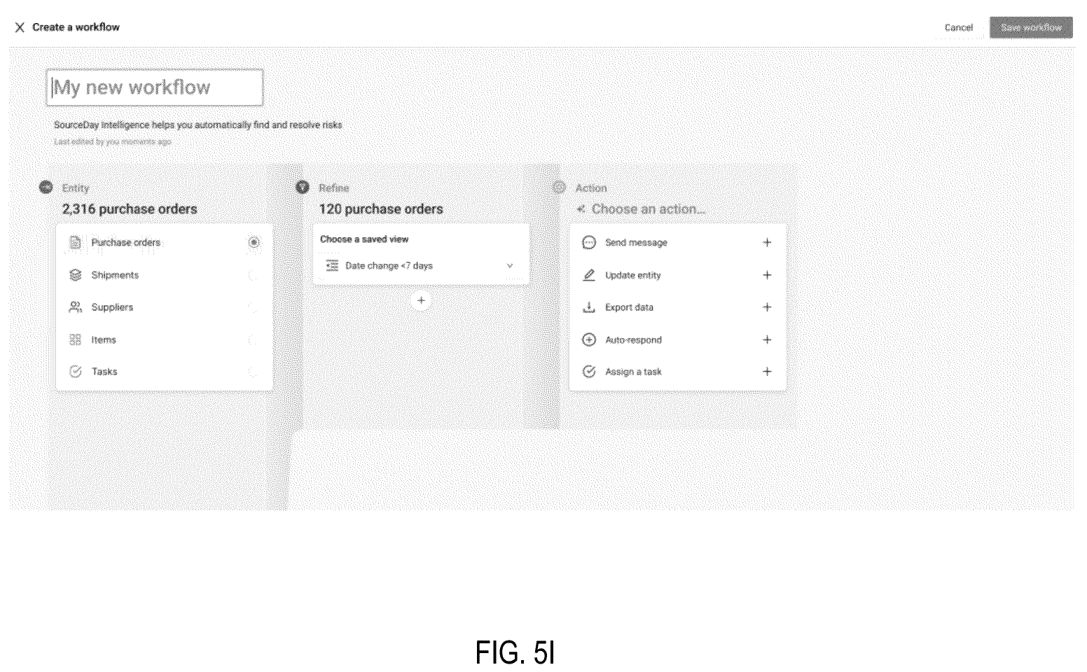

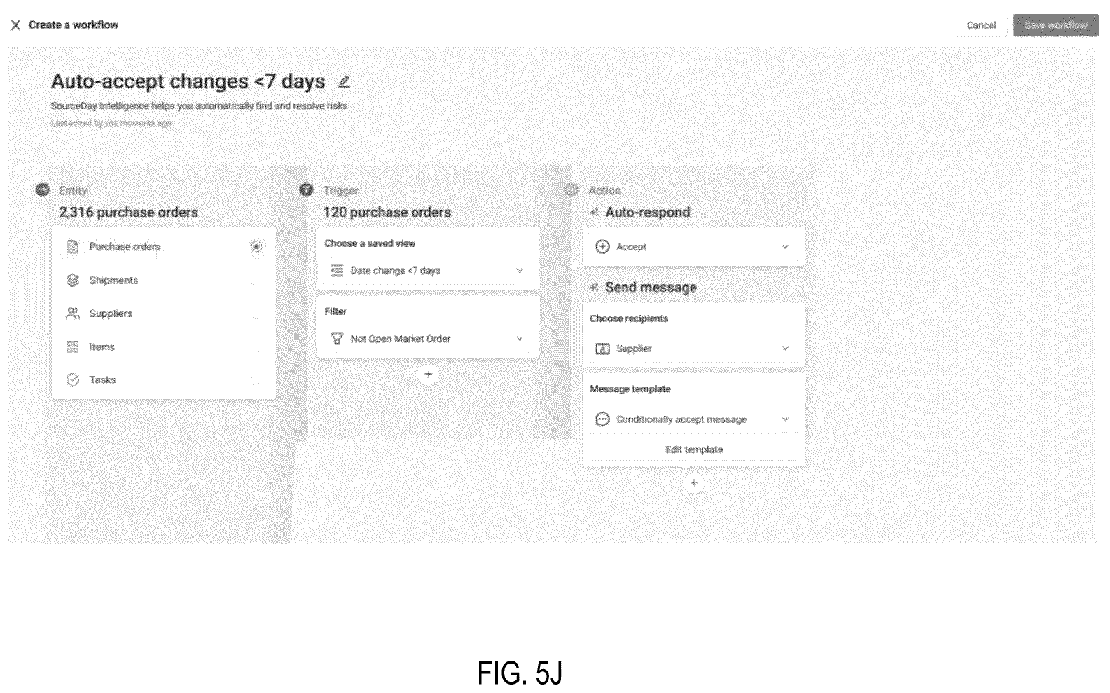

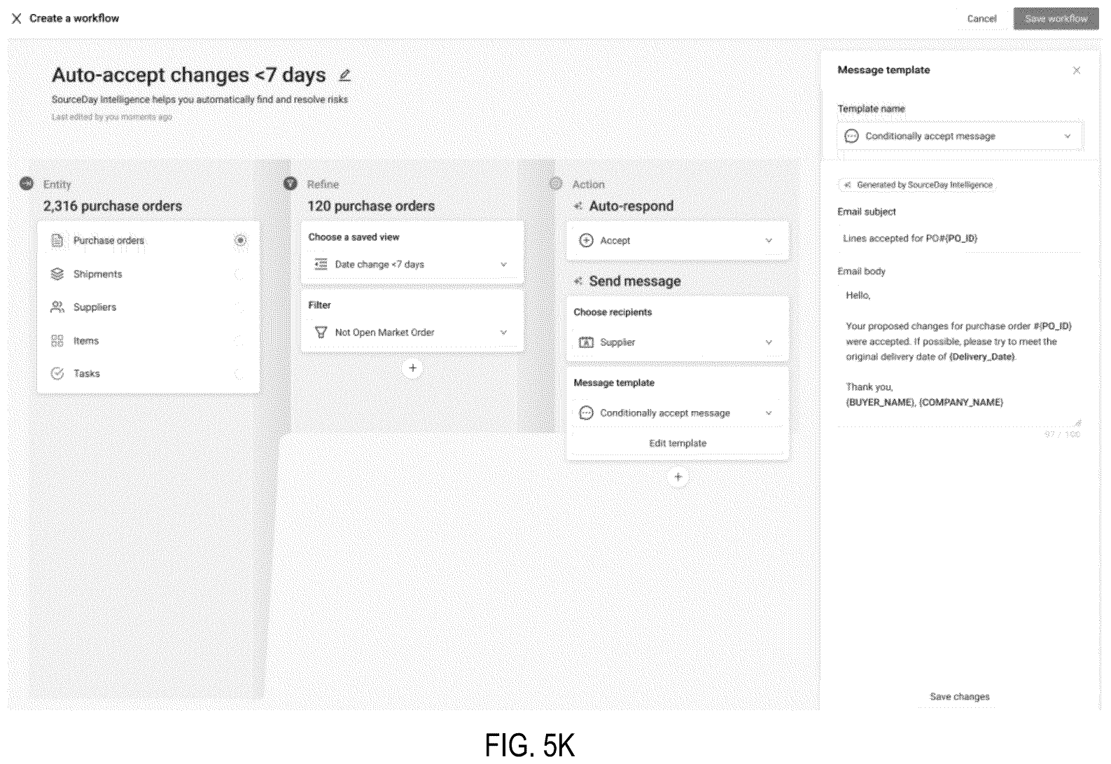

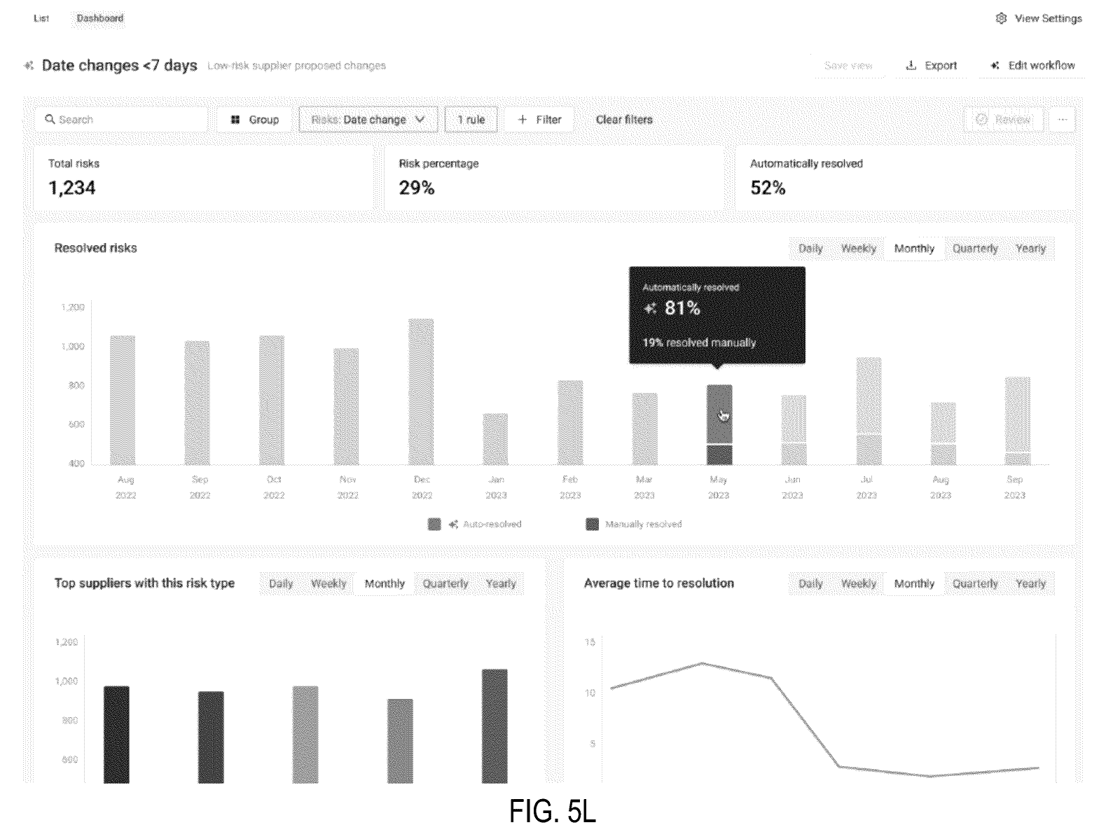

Turning to FIGS. 5A-5L, depicted are non-limiting examples of interfaces of an application associated dashboard of the disclosed framework and how engine 200 can visualize and/or output controls and/or results related to its computational analysis and maintenance of a transaction through its stages until completion. For example, FIG. 5A depicts an example interface where a list of POs are provided, and determined status (e.g., progress through its timeline or sequence of tasks) and identified risks are displayed. As in FIG. 5B, such interface is interactive, in that each form of information is displayed as an IO that is interactive and enables further discovery and/or filtering of information related to types of presented information.

In the example interface depicted in FIG. 5C, the interface provides an update where each PO's order status has changed based on the proposed changes in the “risk” column. For example, if a proposed change for a PO (e.g., via engine 200, as discussed supra, and/or from a supplier, for example) is not approved, then the PO can be canceled. FIG. 5D depicts the functionality for the interface related to the detail of a proposed change, and engine 200's recommended modification to the PO. For example, a supplier proposed a date change of 24 days, while engine 200, via the steps of Process 400, discussed supra, proposed a change closer to the original due date (e.g., within 1-3 business days, for example).

In the example interface depicted in FIG. 5E, the interface provides a depiction of predicted risks. For example, these risks can be predicted via execution of Step 408, which can correspond to prior to commencement of the transaction and/or prior to a task/stage being performed, as discussed above.

In FIG. 5F, the depicted display within the dashboards UI is an example of a result of interaction with an IO of a predicted risk. This provides, as discussed above, a notification of the risk and/or recommended mechanisms for curing the risk. FIG. 5G provides another example of an interactive IO causing a display of risk related and notification related information.

In FIG. 5H, the depiction provides an example interface portion/window that provides details as to engine 200's recommendation for a specific PO. Such displayed information can be subject input to an specific IO (e.g. that relates to a PO, order status, risk, and the like).

In FIGS. 5I-5K, depicted are non-limiting example interfaces for which the disclosed automation operations, as discussed above respective to the steps of Process 400, can be performed. Such automation can enable the event detection, remedial actions and/or PO processing, inter alia, as discussed supra.

FIG. 5L provides an example depiction of a dashboard, which provides the risk assessments, which can be based on, but not limited to, type of entity, ID of entity, number of risks, types of risks, a time period (e.g., past 7 days as depicted in the dashboard), time to resolution, manner of resolution (e.g., automatic, based on engine 200's operation) versus manual, based on entity/supplier, for example, action), and the like.

FIG. 8 is a schematic diagram illustrating a client device showing an example embodiment of a client device that may be used within the present disclosure. Client device 800 may include many more or less components than those shown in FIG. 8. However, the components shown are sufficient to disclose an illustrative embodiment for implementing the present disclosure. Client device 800 may represent, for example, UE 102 discussed above at least in relation to FIG. 1.

As shown in the figure, in some embodiments, Client device 800 includes a processing unit (CPU) 822 in communication with a mass memory 830 via a bus 824. Client device 800 also includes a power supply 826, one or more network interfaces 850, an audio interface 852, a display 854, a keypad 856, an illuminator 858, an input/output interface 860, a haptic interface 862, an optional global positioning systems (GPS) receiver 864 and a camera(s) or other optical, thermal or electromagnetic sensors 866. Device 800 can include one camera/sensor 866, or a plurality of cameras/sensors 866, as understood by those of skill in the art. Power supply 826 provides power to Client device 800.

Client device 800 may optionally communicate with a base station (not shown), or directly with another computing device. In some embodiments, network interface 850 is sometimes known as a transceiver, transceiving device, or network interface card (NIC).

Audio interface 852 is arranged to produce and receive audio signals such as the sound of a human voice in some embodiments. Display 854 may be a liquid crystal display (LCD), gas plasma, light emitting diode (LED), or any other type of display used with a computing device. Display 854 may also include a touch sensitive screen arranged to receive input from an object such as a stylus or a digit from a human hand.

Keypad 856 may include any input device arranged to receive input from a user. Illuminator 858 may provide a status indication and/or provide light.

Client device 800 also includes input/output interface 860 for communicating with external. Input/output interface 860 can utilize one or more communication technologies, such as USB, infrared, Bluetooth™, or the like in some embodiments. Haptic interface 862 is arranged to provide tactile feedback to a user of the client device.

Optional GPS transceiver 864 can determine the physical coordinates of Client device 800 on the surface of the Earth, which typically outputs a location as latitude and longitude values. GPS transceiver 864 can also employ other geo-positioning mechanisms, including, but not limited to, triangulation, assisted GPS (AGPS), E-OTD, CI, SAI, ETA, BSS or the like, to further determine the physical location of client device 800 on the surface of the Earth. In one embodiment, however, Client device 800 may through other components, provide other information that may be employed to determine a physical location of the device, including for example, a MAC address, Internet Protocol (IP) address, or the like.

Mass memory 830 includes a RAM 832, a ROM 834, and other storage means. Mass memory 830 illustrates another example of computer storage media for storage of information such as computer readable instructions, data structures, program modules or other data. Mass memory 830 stores a basic input/output system (“BIOS”) 840 for controlling low-level operation of Client device 800. The mass memory also stores an operating system 841 for controlling the operation of Client device 800.

Memory 830 further includes one or more data stores, which can be utilized by Client device 800 to store, among other things, applications 842 and/or other information or data. For example, data stores may be employed to store information that describes various capabilities of Client device 800. The information may then be provided to another device based on any of a variety of events, including being sent as part of a header (e.g., index file of the HLS stream) during a communication, sent upon request, or the like. At least a portion of the capability information may also be stored on a disk drive or other storage medium (not shown) within Client device 800.

Applications 842 may include computer executable instructions which, when executed by Client device 800, transmit, receive, and/or otherwise process audio, video, images, and enable telecommunication with a server and/or another user of another client device. Applications 842 may further include a client that is configured to send, to receive, and/or to otherwise process gaming, goods/services and/or other forms of data, messages and content hosted and provided by the platform associated with engine 200 and its affiliates.

As used herein, the terms “computer engine” and “engine” identify at least one software component and/or a combination of at least one software component and at least one hardware component which are designed/programmed/configured to manage/control other software and/or hardware components (such as the libraries, software development kits (SDKs), objects, and the like).

Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. In some embodiments, the one or more processors may be implemented as a Complex Instruction Set Computer (CISC) or Reduced Instruction Set Computer (RISC) processors; x86 instruction set compatible processors, multi-core, or any other microprocessor or central processing unit (CPU). In various implementations, the one or more processors may be dual-core processor(s), dual-core mobile processor(s), and so forth.

Computer-related systems, computer systems, and systems, as used herein, include any combination of hardware and software. Examples of software may include software components, programs, applications, operating system software, middleware, firmware, software modules, routines, subroutines, functions, methods, procedures, software interfaces, application program interfaces (API), instruction sets, computer code, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

For the purposes of this disclosure a module is a software, hardware, or firmware (or combinations thereof) system, process or functionality, or component thereof, that performs or facilitates the processes, features, and/or functions described herein (with or without human interaction or augmentation). A module can include sub-modules. Software components of a module may be stored on a computer readable medium for execution by a processor. Modules may be integral to one or more servers, or be loaded and executed by one or more servers. One or more modules may be grouped into an engine or an application.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores,” may be stored on a tangible, machine readable medium and supplied to various customers or manufacturing facilities to load into the fabrication machines that make the logic or processor. Of note, various embodiments described herein may, of course, be implemented using any appropriate hardware and/or computing software languages (e.g., C++, Objective-C, Swift, Java, JavaScript, Python, Perl, QT, and the like).

For example, exemplary software specifically programmed in accordance with one or more principles of the present disclosure may be downloadable from a network, for example, a website, as a stand-alone product or as an add-in package for installation in an existing software application. For example, exemplary software specifically programmed in accordance with one or more principles of the present disclosure may also be available as a client-server software application, or as a web-enabled software application. For example, exemplary software specifically programmed in accordance with one or more principles of the present disclosure may also be embodied as a software package installed on a hardware device.

For the purposes of this disclosure the term “user”, “subscriber” “consumer” or “customer” should be understood to refer to a user of an application or applications as described herein and/or a consumer of data supplied by a data provider. By way of example, and not limitation, the term “user” or “subscriber” can refer to a person who receives data provided by the data or service provider over the Internet in a browser session, or can refer to an automated software application which receives the data and stores or processes the data. Those skilled in the art will recognize that the methods and systems of the present disclosure may be implemented in many manners and as such are not to be limited by the foregoing exemplary embodiments and examples. In other words, functional elements being performed by single or multiple components, in various combinations of hardware and software or firmware, and individual functions, may be distributed among software applications at either the client level or server level or both. In this regard, any number of the features of the different embodiments described herein may be combined into single or multiple embodiments, and alternate embodiments having fewer than, or more than, all of the features described herein are possible.

Functionality may also be, in whole or in part, distributed among multiple components, in manners now known or to become known. Thus, myriad software/hardware/firmware combinations are possible in achieving the functions, features, interfaces and preferences described herein. Moreover, the scope of the present disclosure covers conventionally known manners for carrying out the described features and functions and interfaces, as well as those variations and modifications that may be made to the hardware or software or firmware components described herein as would be understood by those skilled in the art now and hereafter.

Furthermore, the embodiments of methods presented and described as flowcharts in this disclosure are provided by way of example in order to provide a more complete understanding of the technology. The disclosed methods are not limited to the operations and logical flow presented herein. Alternative embodiments are contemplated in which the order of the various operations is altered and in which sub-operations described as being part of a larger operation are performed independently.

While various embodiments have been described for purposes of this disclosure, such embodiments should not be deemed to limit the teaching of this disclosure to those embodiments. Various changes and modifications may be made to the elements and operations described above to obtain a result that remains within the scope of the systems and processes described in this disclosure.

What is claimed is:

1. A method comprising:
identifying, over a network, an electronic data structure related to interactions between a first entity and a second entity, the data structure comprising a set of tasks;
analyzing, upon execution of the data structure in relation to commencement of the set of tasks, each of the set of tasks, the analysis comprising executing an artificial intelligence (AI) application based on information related to the set of tasks;
determining, based on the AI-based analysis, whether an event for a task within the set of tasks is detected, the detection corresponding to determination of a condition that prevents the task from being performed;
executing, by the AI application, the data structure based on the event determination, the execution comprising processing the task and other tasks in the set of tasks of the interactions between the first entity and the second entity in accordance of the determination of the event; and
communicating, over the network, a notification to the first and second entities based on the execution of the data structure.

2. The method of claim 1, further comprising:
causing, over the network, on a display of a device related to at least one of the first entity and second entity, a dashboard, the dashboard comprising interface objects (IOs) that enable display of information related to the event, the IOs further provide functionality for executing control of the execution of the data structure.

3. The method of claim 1, further comprising:
determining that the event is detected for the task;
determining, based on further AI-based analysis, a remedial action for the task that addresses a condition causing the event; and
executing the remedial action.

4. The method of claim 3, wherein execution of the remedial action comprises at least one of modification of the task and modification of the data structure.

5. The method of claim 3, wherein the remedial action comprises altering an initial priority of the set of tasks, wherein the method further comprises:
determining a subset of the set of tasks capable of being performed without a need for performance of the task associated with the event;
determining a priority based on the subset; and
modifying the data structure by altering an initial schedule of the set of tasks in the data structure based on the determined priority.

6. The method of claim 5, further comprising:
executing the modified data structure based on the modified schedule of the set of tasks.

7. The method of claim 1, wherein the event determination comprises an absence of the detection of the event, wherein processing of the set of tasks comprises progressing to a next task until another event is detected.

8. The method of claim 1, further comprising:
analyzing a set of interactions associated with at least one of the first entity and second entity;
determining, based on the analysis of the set of interactions, a set of patterns, the set of patterns comprising a stored pattern of activity for the at least one first entity and second entity; and
storing the determined set of patterns.

9. The method of claim 8, further comprising:
performing the analysis of each of the set of tasks based on the determined set of patterns, wherein the stored pattern of activity is retrieved from the stored determined set of patterns.

10. The method of claim 8, wherein the stored pattern of activity comprises information related to interaction activity related to at least one of an entity type, entity identifier (ID), asset type, transaction type, time, date and location.

11. The method of claim 1, wherein the interactions correspond to at least one of real-world and digital interactions between the first entity and the second entity, the set of tasks correspond to a transfer of at least one of real-world and digital assets from the first entity to the second entity.

12. A system comprising:
a processor configured to:
identify, over a network, an electronic data structure related to interactions between a first entity and a second entity, the data structure comprising a set of tasks;
analyze, upon execution of the data structure in relation to commencement of the set of tasks, each of the set of tasks, the analysis comprising executing an artificial intelligence (AI) application based on information related to the set of tasks;
determine, based on the AI-based analysis, whether an event for a task within the set of tasks is detected, the detection corresponding to determination of a condition that prevents the task from being performed;
execute, by the AI application, the data structure based on the event determination, the execution comprising processing the task and other tasks in the set of tasks of the interactions between the first entity and the second entity in accordance of the determination of the event; and
communicate, over the network, a notification to the first and second entities based on the execution of the data structure.

13. The system of claim 12, wherein the processor is further configured to:
cause, over the network, on a display of a device related to at least one of the first entity and second entity, a dashboard, the dashboard comprising interface objects (IOs) that enable display of information related to the event, the IOs further provide functionality for executing control of the execution of the data structure.

14. The system of claim 12, wherein the processor is further configured to:
determine that the event is detected for the task;
determine, based on further AI-based analysis, a remedial action for the task that addresses a condition causing the event; and
execute the remedial action.

15. The system of claim 14, wherein execution of the remedial action comprises at least one of modification of the task and modification of the data structure.

16. The system of claim 14, wherein the remedial action comprises altering an initial priority of the set of tasks, wherein the processor is further configured to:
determine a subset of the set of tasks capable of being performed without a need for performance of the task associated with the event;
determine a priority based on the subset;
modify the data structure by altering an initial schedule of the set of tasks in the data structure based on the determined priority; and
executing the modified data structure based on the modified schedule of the set of tasks.

17. The system of claim 12, wherein the event determination comprises an absence of the detection of the event, wherein processing of the set of tasks comprises progressing to a next task until another event is detected.

18. The system of claim 12, wherein the processor is further configured to:
analyze a set of interactions associated with at least one of the first entity and second entity;
determine, based on the analysis of the set of interactions, a set of patterns, the set of patterns comprising a stored pattern of activity for the at least one first entity and second entity;
store the determined set of patterns; and
perform the analysis of each of the set of tasks based on the determined set of patterns, wherein the stored pattern of activity is retrieved from the stored determined set of patterns, wherein the stored pattern of activity comprises information related to interaction activity related to at least one of an entity type, entity identifier (ID), asset type, transaction type, time, date and location.

19. The system of claim 12, wherein the interactions correspond to at least one of real-world and digital interactions between the first entity and the second entity, the set of tasks correspond to a transfer of at least one of real-world and digital assets from the first entity to the second entity.

20. A non-transitory computer-readable storage medium tangibly encoded with computer-executable instructions that when executed by a device, perform a method comprising:
identifying, over a network, an electronic data structure related to interactions between a first entity and a second entity, the data structure comprising a set of tasks;
analyzing, upon execution of the data structure in relation to commencement of the set of tasks, each of the set of tasks, the analysis comprising executing an artificial intelligence (AI) application based on information related to the set of tasks;
determining, based on the AI-based analysis, whether an event for a task within the set of tasks is detected, the detection corresponding to determination of a condition that prevents the task from being performed;
executing, by the AI application, the data structure based on the event determination, the execution comprising processing the task and other tasks in the set of tasks of the interactions between the first entity and the second entity in accordance of the determination of the event; and
communicating, over the network, a notification to the first and second entities based on the execution of the data structure.
